(19) United States
(12) Patent Application Publication
(10) Pub. No.: US 2003/0098571 A1
(43) Pub. Date: May 29, 2003

(54) Airbag module

(76) Inventors: Markus Jost, Florsheim a.M (DE); Michael Grosch, Ingelheim (DE); Frank Szceburek, Langenselbold (DE); Detlef Munsch, Wiesbaden (DE); Burkhard Stich, Bingen (DE)

Correspondence Address: Lonnie R. Drayer, Breed Technologies, Inc., P.O. Box 33050, Lakeland, FL, 33807-3050, US

(21) Appl. No.: 10/146,940

(22) Filed: May 17, 2002

(30) Foreign Application Priority Data
Nov. 23, 2001 (DE) 101 57 440.1

(51) Int. Cl. B60R 21/16

(52) U.S. Cl. 280/728.2

(57) ABSTRACT

An airbag module has a housing with side walls and a base plate, on which a gas generator is mounted. A cover plate is located on the free ends of the side walls for closing the airbag module. The housing is provided with a latching or snap-action device for the latching arrangement of the airbag module on a component of the vehicle, in particular on a steering wheel. The latching device is formed as an integral part of the housing on the side walls and/or on the base plate of the housing, such that the airbag module is mounted solely by the latching device on the appropriate part of the vehicle.

### FIELD OF THE INVENTION

The present invention relates to an airbag module mountable on a vehicle component such as a steering wheel.

### BACKGROUND OF THE INVENTION

An airbag module comprises a housing, a cover with a folded airbag located in the housing and at least one gas generator, are assembled before being mounting on or in a vehicle. The airbag module is fastened to a vehicle in such a way that, on the one hand, reliable support is guaranteed and, on the other hand, in the event of triggering of the airbag the airbag module remains at the specially provided point in the vehicle and only releases the airbag. As a result, the fastening of the airbag modules in the vehicle has to meet high standards.

Should an airbag module be located for example in the steering wheel of a vehicle, additional fastening means are necessary in order to be able to dispose the airbag module securely on the steering wheel armature. It is known to screw-fasten the airbag module to the steering wheel armature or to a movable horn plate by nuts fastened in the module housing and separate screws. Said screw fastening may also be effected conversely in that bolts or screws fixed in the airbag module are then screw-fastened by a separate nut. Separate leg springs or snap rings are also used, which cooperate with latching hooks or other suitable components additionally provided on the airbag module. Thus, for disposing or mounting the airbag module on a component of the vehicle it has hitherto always been necessary to provide additional elements on the airbag module.

### SUMMARY OF THE INVENTION

There is provided in accordance with one aspect of the invention an airbag module comprising: a housing that has side walls that have free ends; a base plate on which a gas generator is mounted; a cover plate located on the free ends of the side walls for closing the airbag module; the housing is provided with a latching device for the mounting of the airbag module on a vehicle component, wherein the latching device is an integral part of the housing on the side walls and/or the base plate of the housing such that the airbag module is mounted on the vehicle component solely by the latching device.

There is provided in accordance with another aspect of the invention a steering wheel having an airbag module mounted on the steering wheel, wherein the airbag module comprises: a housing that has side walls that have free ends; a base plate on which a gas generator is mounted; a cover plate located on the free ends of the side walls for closing the airbag module; the housing is provided with elastically deformable spring elements for the mounting of the airbag module on steering wheel wherein the spring elements are an integral part of the housing on the side walls and/or the base plate of the housing such that the airbag module is mounted on the vehicle steering wheel solely by the spring elements.

The latching device of the airbag module advantageously cooperates with components of the vehicle such as latching lugs and/or latching openings for the purpose of latching of the airbag module to the appropriate component of the vehicle, in that the latching device of the airbag module engages behind or around and/or projects into the appropriate latching lugs and/or latching openings. Thus, on the vehicle too it is possible to dispense with additional components for the purpose of arranging the airbag, wherein the vehicle-side latching devices may easily be taken into consideration when manufacturing the appropriate components of the vehicle, for example the steering wheel, and provided in one working cycle without much extra outlay. The latching device on the vehicle is a rigid component so the latching device located on the airbag module may engage behind or around or project into the suitably rigid parts.

### BRIEF DESCRIPTION OF THE DRAWINGS

FIG. 1 is a perspective view of a latching device of an airbag module according to the invention.

FIGS. 2a to 2c are diagrammatic views of insertion of the airbag module according to FIG. 1 into a steering wheel armature.

FIG. 3 is a perspective view of a base plate of an airbag module with the latching device according to the invention.

FIG. 4 is a perspective view of a base plate with an alternative embodiment of the latching device according to the invention.

### DETAILED DESCRIPTION OF THE INVENTION

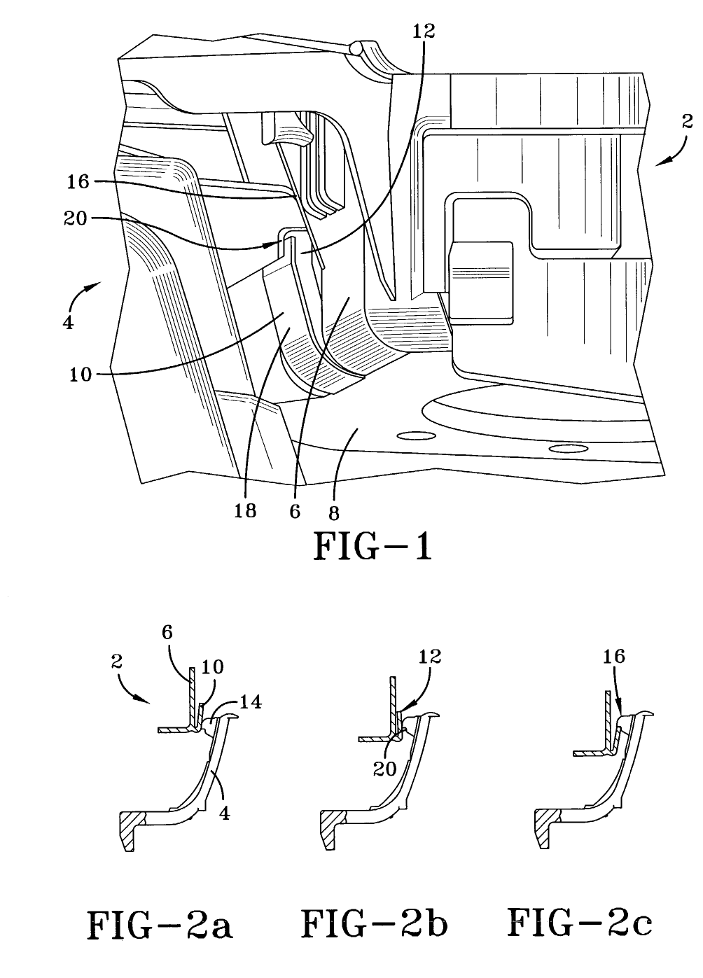

FIG. 1 is a perspective view of a part of an airbag module 2 of the type mounted in the steering wheel armature of a steering wheel. The housing of the airbag module 2 comprises sidewalls 6 and a base plate 8. Formed in a region of the sidewall 6 is a latching device in the form of a spring element or of a spring clip 10, for example in the form of tongues, which are formed on and project outwards from the side walls of the airbag module and behind the free ends of which a corresponding vehicle-side latching device, for example in the form of latching lugs, engages. The spring clip 10 is an integral component of the side wall 6 and is formed simultaneously with manufacture of the housing for the airbag module 2 in that a region of the side wall 6 is designed so as to stand away from the latter. This forms the spring clip 10, which is directed out from the side wall 6 and which in its lower region is connected to the side wall 6 and the upper region of which has a free end 12. The airbag module has a plurality of spring clips 10 located in the sidewalls 6.

The side walls of the airbag module are usually made of a plastic material, wherein their manufacture may be manufactured for example by injection molding. In said case, it is easily possible to provide regions in the side walls of the airbag module with slots extending in a U-shaped manner and to design the part of the side walls bounded by the U-shaped region such that said part projects outwards and may therefore serve as a latching tongue. The stability of the latching tongues thus manufactured is in said case designed such that the airbag module upon triggering of the airbag remains at the specially provided point, i.e. the outwardly projecting spring elements are so designed that they may absorb the occurring forces without being destroyed and the airbag module remains at the specially provided point.

The spring elements enable easy insertion of the airbag module at the specially provided point, whereby through suitable development of the latching devices corresponding with the spring elements an easy insertion may be enabled in that the spring elements or spring clips are moved away during insertion and then return to their starting position after they have latched or snapped into place at the specially provided point.

On the steering wheel 4 latching devices in the form of a latching lug 14, which may also be described as the airbag module anchoring, are provided and cooperate with the latching device of the airbag module 2 in the form of the spring clip 10. The latching lug 14 is chamfered in the direction of insertion of the airbag module, i.e. in FIG. 1 in a downward direction, so that the latching lug 14 at its free end directed towards the airbag module 2 has a ramp 16. The latching lug 14 is shaped such that it has, in the direction of insertion of the airbag module 2, its shortest extension at the beginning, viewed in the direction of the center of the steering wheel. The slope of the ramp 16 is therefore directed towards the center of the steering wheel. As the airbag module 2 is inserted, the outer region 18 of the spring clip 10 directed towards the latching lug 14 slides along the ramp 16 and, because of the slope of the ramp 16, is in the course of insertion pressed away in the direction of the housing wall 6. Owing to the elastic design of the spring clip 10 this is possible in a non-destructive manner. The airbag module 2 is inserted until the free end 12 of the spring clip 10 has reached the end of the ramp 16 and may once more move outwards, away from the housing side wall, before jamming underneath the latching lug 14. To limit the movement of the spring clip 10 away from the side wall 6, the end of the ramp 16 of the latching lug 14 has a boundary wall 20, against which the outer region 18 of the free end 12 of the spring clip 10 comes to rest. Thus, the free end of the spring clip 10 engages below the latching lug 14 at the end of the ramp 16 and therefore fixes the airbag module 2 in its end position. As may be seen, for insertion of the airbag module it is not necessary to use additional fastening means or to employ special tools. The airbag module 2 merely has to be moved in the direction of insertion until the spring clips 10 engage in a clamping manner under the corresponding latching lugs 14. Nor, when an airbag housing developed in said manner is removed, are special tools required; rather, a simple screwdriver or similar devices may be used to press the spring clips 10 in towards the housing wall 6 before removing the airbag module from the steering wheel 4. Furthermore, the latching device may be located on the airbag module in such a way that easy access to the latching devices after installation of the airbag module may be guaranteed.

It may be advantageous to form the latching device additionally or exclusively on the base plate of the airbag module, namely by spring elements, which extend substantially vertically away and which are then an integral part of the base plate. As the base plate, which is generally used for arrangement of the gas generator, will usually be made of metal, the latching device formed from parts of the base plate presents the required material stability. As in the case of the spring elements formed in the sidewalls, the spring elements formed in the region of the base plate are also easy and therefore very inexpensive to manufacture.

In an advantageous manner the latching device, for example in the form of spring elements, located on the base plate may take the form of regions or parts bent away from the free edge of the base plate, which merely involves slitting and then bending away the specific regions, a process which is likewise easy and inexpensive to effect. For the situation where the base plate of the airbag module has an opening, for example for arrangement of the gas generator and/or a diffuser, the latching device formed on the base plate and for example in the form of spring elements may comprise parts bent away from the region delimiting the opening of the base plate, and this is likewise easy to effect.

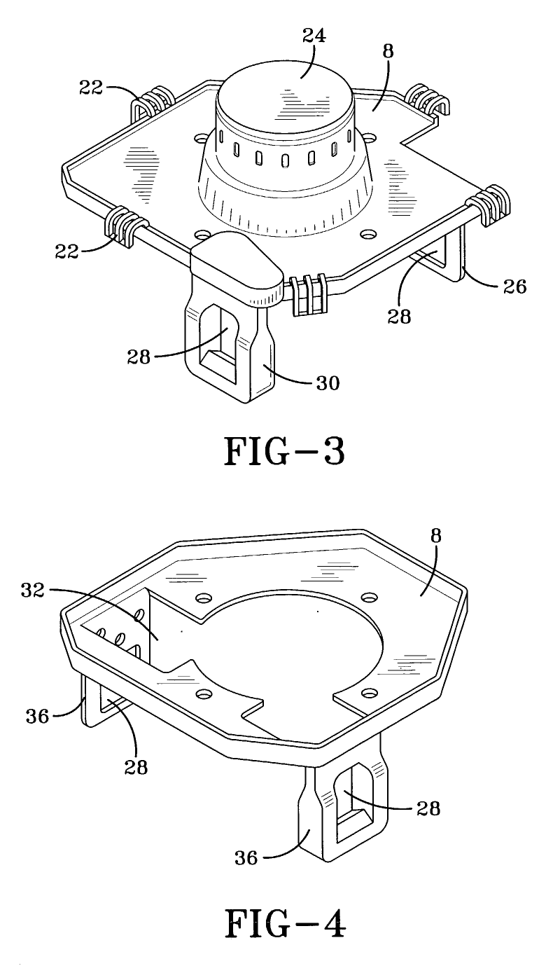

The process, just described, of installing the airbag module 2 into a steering wheel armature is diagrammatically illustrated in individual stages in FIGS. 2a to 2c. In FIG. 2a the spring clip 10 during insertion is positioned for the first time against the latching lug 14 of the steering wheel 4. As the airbag module 2 in said position comes with the spring clips 10 for the first time into abutment with the latching lugs 14, the spring clips 10 have not yet been bent away in the direction of the housing wall 6. Said state, in which the spring clips 10 are bent away as a result of further insertion of the airbag module 2 into the steering wheel 4, is shown in FIG. 2b. FIG. 2c shows how the free end 12 of the spring clip 10 has reached the end of the ramp 16 and because of springing-back of the latching lug 14 at the end of the ramp 16 may move back out, away from the housing wall 6. Moving away is however possible only until the outer region of the spring clip 10 in the region of its free end 12 has reached the boundary wall 20 of the latching lug 14.

In said development, upon deploying the airbag the spring clips 10 are subjected to compressive stress in that the free ends 12 of the spring clips 10 are supported against the offset of the latching lug 14 and therefore upset the spring clip 10, i.e. subject it to compressive stress.

FIG. 3 shows another development of the latching device of an airbag module, namely in the region of the base plate 8 of the airbag module. It is self-evident that the latching devices illustrated here may be provided on an airbag module in addition to the latching devices according to FIG. 1 or alternatively as a single latching device of the airbag module. The base plate 8 is shown without any connection to the sidewalls of the airbag module. The hooks 22, which project out from the outer edge of the base plate 8 and are directed downwards, are used to fasten the airbag. Located in the middle of the base plate 8 is a diffuser 24. Provided at the outer edge of the base plate 8 are latching devices in the form of spring clips 26, 30, which extend away from the base plate—in FIG. 3 in a downward direction, i.e. in the direction of insertion of the airbag module or opposite the cover of the airbag module (not shown here). The spring clips 26, 30 are an integral part of the base plate 8 and are produced by bending away a region at the outside edge of the base plate 8 in a downward direction. The illustrated spring clip 26 has an opening 28 surrounded by the material of the spring clip 26. To avoid loose fit or noises in the region of the spring clip 26 when the latter is fastened on or in the vehicle, the spring clip 26 may also be coated with a plastic material, as is illustrated for the spring clip 30, wherein the coating is designed such that the opening 28 is retained. The spring clips 26, 30 may then cooperate with latching lugs located on the vehicle side, in particular on the steering wheel armature, in that the free ends of the latching lugs engage into the openings 28, wherein the latching lugs (not shown here) may in a corresponding manner be provided with a ramp of the type shown in FIGS. 1 and 2. Because of a ramp-like design of the corresponding latching devices on the steering wheel armature the spring clips 26, 30 may be pressed away, for example in toward the middle of the base plate 8, before then snapping in their end position over the latching lugs, fastening themselves in a secure manner on the latter and ensuring reliable positioning of the airbag module.

FIG. 4 likewise shows a base plate 8 of a non-illustrated airbag module, wherein the base plate 8 has a central opening 32, into which, or at which, a gas generator is subsequently mounted. The construction of the latching device of the base plate 8 in the form of spring elements 34, 36 corresponds to the development of the spring clips 26, 30 of FIG. 3, wherein the spring clip 34 is shown without a plastic coating, while the spring clip 36 has a plastic coating. Both spring clips 34, 36 likewise have the opening 28 for engagement of the vehicle-side latching devices. Said form of construction differs from that of FIG. 3 in that the spring clips 34, 36 are formed from the inner periphery of the opening 32 downwards, i.e. in the direction of insertion of the airbag module. Just as in FIG. 3, the spring clips 34, 36 are subjected to tensile stress in the event of triggering of the airbag.

The disclosed housing for an airbag module eliminates the need for separate parts for fastening the airbag module because the latching or snap-action device is provided on the airbag module itself, i.e. on the housing or base plate of the latter, as an integral component. This not only cuts down cost because there are fewer parts but also reduces the weight of the airbag module. A further result is an optimum utilization of installation space. By integrating the latching device in the airbag module a latching or snapping into place of the airbag module, for example in the steering wheel of a vehicle, is effected without additional components and, what is more, no special tools are required for installation or removal. By virtue of the latching device being integrated in the airbag module the latching device is connected to the airbag module. It is in said case self-evident that the latching device is designed to be indestructible and reusable as often as desired, so that the airbag module where necessary, for example for substitute servicing or other requirements, may easily be removed from the vehicle without impairing the function of the latching device. The airbag module is in said case mounted solely by the latching device on the appropriate component of the vehicle.

With a suitably developed housing, comprising the side walls and the base plate, an airbag module may be provided, which additionally comprises at least one folded airbag, a gas generator and a cover for closing the housing, wherein an airbag module thus developed may be easily, quickly and inexpensively fastened on or in the vehicle and removed again but at the same time, in the event of deployment of the airbag, remains securely at the specially provided point.

In a corresponding manner steering wheels for vehicles may be provided which enable an arrangement of an airbag module, wherein the airbag module comprises a housing of a corresponding design and hence the described latching device, wherein the steering wheel has latching lugs and/or latching openings for cooperation with the latching device of the airbag module.

Many changes and modifications in the above described embodiment of the invention can, of course, be carried out without departing from the scope thereof. Accordingly, that scope is intended to be limited only by the scope of the appended claims.

We claim:

1. An airbag module comprising:
a housing that has side walls that have free ends;
a base plate on which a gas generator is mounted;
a cover plate located on the free ends of the side walls for closing the airbag module;
the housing is provided with a latching device for the mounting of the airbag module on a vehicle component, wherein the latching device is an integral part of the housing on the side walls and/or the base plate of the housing such that the airbag module is mounted on the vehicle component solely by the latching device.

2. The airbag module according to claim 1 wherein the vehicle component is a steering wheel.

3. The airbag module according to claim 1, wherein the latching device comprises elastically deformable spring elements.

4. The airbag module according to claim 1, wherein the latching device cooperates with a component of the vehicle in the form of latching lugs for latching the airbag module to the vehicle component such that the latching device engages the latching lugs.

5. The airbag module according to claim 1, wherein the latching device cooperates with a component of the vehicle in the form of latching openings for latching the airbag module to the vehicle component such that the latching device engages the latching openings.

6. The airbag module according to claim 1, wherein for removal of the airbag module is removably mounted on the vehicle component.

7. The airbag module according to claims 1, wherein the latching device comprises spring elements, which are formed on the side walls of the airbag module and project outwards therefrom, the free ends of which engage behind corresponding latching lugs located on the vehicle.

8. The airbag module according to claim 1, wherein the latching device comprises spring elements, which are formed on the base plate of the airbag module and extend substantially vertically away from said base plate.

9. The airbag module according to claim 7, wherein the spring elements have recesses therein, into which latching lugs located on the vehicle component engage.

10. The airbag module according to claim 7, wherein the spring elements have openings therein, into which latching lugs located on the vehicle component engage.

11. The airbag module according to claim 8, wherein the spring elements have recesses therein, into which latching lugs located on the vehicle component engage.

12. The airbag module according to claim 8, wherein the spring elements have openings therein, into which latching lugs located on the vehicle component engage.

13. The airbag module according to claim 8, wherein the spring elements located on the base plate are formed from parts bent away from the free edge of the base plate.

14. The airbag module according to claim 11, wherein the spring elements located on the base plate are formed from parts bent away from the free edge of the base plate.

15. The airbag module according to claim 12, wherein the spring elements located on the base plate are formed from parts bent away from the free edge of the base plate.

16. The airbag module according to claim 3, wherein the base plate has an opening therein for receiving at least a portion the gas generator and the spring elements located on the base plate comprise parts which are bent away from the region of the base plate delimiting said opening.

17. The airbag module according to claim 3, wherein the spring elements of the base plate are coated with a plastic material.

18. A steering wheel having an airbag module mounted on the steering wheel, wherein the airbag module comprises:
a housing that has side walls that have free ends;
a base plate on which a gas generator is mounted;
a cover plate located on the free ends of the side walls for closing the airbag module;
the housing is provided with elastically deformable spring elements for the mounting of the airbag module on steering wheel wherein the spring elements are an integral part of the housing on the side walls and/or the base plate of the housing such that the airbag module is mounted on the vehicle steering wheel solely by the spring elements.
